(19) United States
(12) Patent Application Publication
(10) Pub. No.: US 2026/0352379 A1
(43) Pub. Date: Nov. 5, 2026

(54) Avoidance of Unnecessary Retransmission in Wireless Communications

(71) Applicant: Sharp Kabushiki Kaisha, Sakai City (JP)

(72) Inventors: Sangkyu BAEK, Vancouver, WA (US); Atsushi ISHII, Vancouver, WA (US); Tomoki YOSHIMURA, Camas, WA (US); Zhanping YIN, Vancouver, WA (US)

(21) Appl. No.: 19/195,470

(22) Filed: Apr. 30, 2025

(51) Int. Cl. H04L 1/1809; H04L 5/00

(52) U.S. Cl. CPC H04L 1/1809; H04L 5/0055

(57) ABSTRACT

A node of a telecommunications system comprises at least one processor which is configured to obtain a predetermined indication for a packet or a packet portion which has previously been transmitted and to avoid retransmission of the packet or the packet portion for which the predetermined indication has been obtained.

### TECHNICAL FIELD

The technology relates to wireless communications, and particularly to avoiding unnecessary retransmission, e.g., of outdated data, in a wireless communications system.

### BACKGROUND

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and NG-UTRAN, the New Radio (NR).

A radio access network may comprise one or more access nodes, such as base station nodes, which facilitate wireless communication or otherwise provides an interface between a wireless terminal and a communications system. A non-limiting example of a base station can include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth-generation system, e.g., the 5G System, also called “NR” or “New Radio”, as well as “NG” or “Next Generation”, is shown in FIG. 1, and is also described in 3GPP TS 38.300. The 5G NR network is comprised of NG RAN (Next Generation Radio Access Network) and 5GC (5G Core Network). As shown, NGRAN is comprised of gNBs (e.g., 5G Base stations) and ng-eNBs (i.e. LTE base stations). An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations (i.e. gNB & ng-eNB). A gNB node provides NR user plane and control plane protocol terminations towards the UE and is connected via the NG interface to the 5GC. The 5G NR (New Radio) gNB is connected to AMF (Access and Mobility Management Function) and UPF (User Plane Function) in 5GC (5G Core Network).

The Open Systems Interconnection, OSI, model is a reference framework that explains the process of transmitting data between computers. It is divided into seven layers that work together to carry out specialized network functions, allowing for a more systematic approach to networking. Information transferred from one device to another device travels through 7 layers of OSI model. First data travels down through 7 layers from the sender's end and then climbs back 7 layers on the receiver's end. Data flows through the OSI model in a step-by-step process:
Layer 7: Application Layer: Applications create the data.
Layer 6: Presentation Layer: Data is formatted and encrypted.
Layer 5: Session Layer: Connections are established and managed.
Layer 4: Transport Layer: Data is broken into segments for reliable delivery.
Layer 3: Network Layer: Segments are packaged into packets and routed.
Layer 2: Data Link Layer: Packets are framed and sent to the next device.
Layer 1: Physical Layer: Frames are converted into bits and transmitted physically.

A protocol stack may comprise different individual protocols. Protocols may be simply described as a set of rules that allow communication between peer entities or they can also be described as a set of rules that facilitate horizontal communication. These protocols may be arranged in the layers such as those described above. In a transmitter side, a layer N receives data from layer N+1 and this data is called the SDU or Service Data Unit. This layer will modify the data and convert it into a PDU or a Protocol Data Unit. The peer entity in the receiver is only able to understand this PDU. In the receiver side, the peer entity receives the PDU from layer N−1, e.g., actually layer N−1 SDU, and converts it back into SDU(s) and passes it to layer N+1.

Radio Link Control (RLC) is a layer 2 Radio Link Protocol used in UMTS, LTE and 5G on the Air interface. This protocol is specified by 3GPP in TS 25.322 for UMTS, TS 36.322 for LTE and TS 38.322 for 5G New Radio (NR). RLC is located on top of the 3GPP MAC-layer and below the packet data convergence protocol (PDCP) layer. The main tasks of the RLC protocol are:
Transfer of upper layer Protocol Data Units (PDUs) in one of three modes: Acknowledged Mode (AM), Unacknowledged Mode (UM) and Transparent Mode (TM)
Error correction through ARQ (only for AM data transfer)
Segmentation and reassembly of RLC SDUs (UM and AM)
Re-segmentation of RLC data PDUs (AM)
Reordering of RLC data PDUs (UM and AM)
Duplicate detection (UM and AM)
RLC SDU discard (UM and AM)
RLC re-establishment
Protocol error detection and recovery

The Radio Resource Control (RRC) plays a role in managing the radio resources between the User Equipment (UE) and the 5G New Radio (NR) network. The major functions of the RRC protocol include connection establishment and release functions, broadcast of system information, radio bearer establishment, reconfiguration and release, RRC connection mobility procedures, paging notification and release and outer loop power control. By means of the signaling functions the RRC configures the user and control planes according to the network status and allows for Radio Resource Management strategies to be implemented.

The Medium Access Control layer plays a role in managing radio resources and ensuring efficient communication within networks. It operates just above the physical layer (PHY) and below the radio link control (RLC) and the packet data convergence protocol (PDCP) layers. The medium access control (MAC) is the layer that controls the hardware responsible for interaction with the wired or wireless transmission medium. Functions performed by the MAC layer include the following:
Resource Allocation: The MAC layer allocates resources (e.g., time, frequency, and code resources) to connected user equipment (UEs) to facilitate efficient data transmission.
Scheduling: It determines which UEs can transmit data and when, taking into account various factors like Quality of Service (QoS) requirements, traffic types, and channel conditions.
HARQ (Hybrid Automatic Repeat reQuest): The MAC layer handles HARQ processes, enabling retransmissions of data packets in case of errors.
Logical Channels: It manages logical channels for control information exchange between the

MAC layer and higher-layer protocols.
Multiplexing and De-Multiplexing: MAC layer multiplexes and de-multiplexes data flows from different UEs onto the shared radio resources.
PDCCH (Physical Downlink Control Channel): MAC plays a role in the allocation and signaling of PDCCH resources for control information transmission.
User Plane and Control Plane MAC Functions: MAC functions are divided into User Plane (UP) and Control Plane (CP) categories, each serving specific purposes. The UP MAC manages the transmission and reception of user data, while the CP MAC handles control signaling and coordination between the UE and the network.

Thus, functions performed by the MAC layer include:
Frame delimiting and recognition
Addressing of destination stations (both as individual stations and as groups of stations)
Conveyance of source-station addressing information
Transparent data transfer of MAC PDUs, or of equivalent information in the Ethernet sublayer
Protection against errors, generally by means of generating and checking frame check sequences
Control of access to the physical transmission medium

A RRC is in control of the MAC configuration. A MAC entity of a wireless terminal serves many functions, including handling the following transport channels:
Broadcast Channel (BCH)
Downlink Shared Channel(s) (DL-SCH)
Paging Channel (PCH)
Uplink Shared Channel(s) (UL-SCH)
Random Access Channel(s) (RACH).

The access stratum, AS, is a functional layer in protocol stacks between a radio network and user equipment. The access stratum is responsible, e.g., for transporting data over the wireless connection and managing radio resources.

Wireless communication systems typically utilize retransmission, e.g., the resending of packets which have been either damaged or lost. Retransmission is one of the basic mechanisms used to provide more reliable communication. Retransmission can be implemented in various ways and may be occasion, interject, involve, or be associated with various problems.

As used herein, a packet may comprise one or more service data units (SDUs), and when a packet does comprise plural SDUs, a subset of the SDUs of the packet may be referred to as a “packet portion” or “portion of a packet” or a “packet segment”. An SDU may also be referred to as a “data unit”.

### First Problem: Duplicate Retransmission(s)

In 3GPP Release 19 standards, a mechanism to stop transmission and reception of an outdated service data unit (SDU) is introduced as a feature to avoiding unnecessary retransmission of outdated data. The main principle of this feature is that the transmitter stops the retransmission of outdated SDUs, and the receiver abandons the reception of the outdated SDUs. To determine when the receiver abandons the reception, a receiver-side timer called t-RxDiscard is introduced.

FIG. 2 depicts an example of transmission, TX, and reception, RX, operations regarding t-RxDiscard timer. The t-RxDiscard timer starts when the receiver detects a transmission failure. Upon expiry of t-RxDiscard timer, the receiver abandons the outdated SDU and triggers an RLC status report to deliver the reception status to the transmitter. In the example, a status report with an (acknowledged sequence number), ACK_SN, set to 10 and negative acknowledged sequence number field, NACK, set to 5, 7, and 8. The ACK_SN and NACK field in the example of FIG. 2 indicate that all SDUs whose sequence number, SN, is smaller than 10 are successfully received except SDU with SNs 5, 7 and 8, e.g., SDU 5, SDU 7 and SDU8. After the transmitter receives a status report, the transmitter considers negative acknowledged SDUs for retransmission. In the example of FIG. 2, the transmitter considers SDUs 5, 7, and 8, e.g., SDUs with SNs 5, 7, and 8, for retransmission. When the transmitter receives a transmission resource for those SDUs, e.g., a UL-SCH resource in uplink from UE to the gNB or DL-SCH resource in downlink from the gNB to UE), the transmitter performs the retransmissions by submitting Radio Link Control, RLC, Protocol Data Unit, PDU, e.g., a Radio Link Control Protocol Data Unit, RLC PDU, to the medium access control, MAC, sublayer.

FIG. 3 and FIG. 4 depict a problem of duplicate retransmissions. The NACK_SN included in a status report triggers a retransmission of the SDU with SN indicated as NACK_SN. Both t-reassembly timer and t-RxDiscard timer trigger a retransmission. If a status report triggered by t-reassembly expiry and a status report triggered by t-RxDiscard occur within a short period of time, duplicate retransmissions may happen. The t-reassembly timer is used to request retransmissions whereas t-RxDiscard timer is used to stop transmission or retransmission of outdated SDU. Those two timers are working almost independently.

The example of FIG. 3 and FIG. 4 assumes that t-reassembly expires at T0. The reception status immediately before T0 is that the receiver received SDU0, SDU1, SDU4, SDU6, SDU9 and SDU11 successfully, and all other SDUs are not received yet. RX_Next_Highest, RX_Next_Status_Trigger, RX_Highest_Status, RX_Next, and RX_Next_Disard_Trigger are set to 12, 10, 7, 2, and 5, respectively. The definition of those state variables are from 3GPP TS 38.322 NR RLC specification. Upon t-reassembly expiry at T0, a status report with ACK_SN=10 and NACK_SN=2, 3, 5, 7, 8 is triggered and sent to the transmitter. The receiver updates its state variables. The updated values of RX_Next_Highest, RX_Next_Status_Trigger, RX_Highest_Status, RX_Next, and RX_Next_Disard_Trigger are 12, 12, 10, 2, and 5, respectively. Based on the status report, the transmitter considers SDU2, SDU3, SDU5, SDU7, and SDU8 for retransmission. When the transmitter receives a transmission resource, the transmitter performs a retransmission for SDU2, SDU3, SDU5, SDU7, and SDU8. But those transmissions may experience delay due to hybrid ARQ (HARQ) retransmissions. The example of FIG. 3 and FIG. 4 assumes that none of those SDUs are successfully transmitted to the receiver, e.g., not successfully received by the receiver, until t-RxDiscard expiry at T1. Since RX_Next_Discard_Trigger at the expiry of t-RxDiscard is 5, the receiver of FIG. 3 considers all unreceived SDUs whose SN is smaller than 5 (i.e. SDU 2 and SDU3) as outdated SDUs. It is considered as received and RX_Next is updated to 5. Similar to t-reassembly expiry, a status report is triggered and sent to the transmitter. The status report with ACK_SN=10 and NACK_SN=5, 7, 8 is triggered and sent to the transmitter. Based on the status report, the transmitter considers SDU5, SDU7, and SDU8 for retransmission. When the transmitter receives a transmission resource, the transmitter performs a retransmission for SDU5, SDU7, and SDU8.

The problem in the FIG. 3 and FIG. 4 example scenario is that the second retransmission of SDU5, SDU7 and SDU8 may be performed during the ongoing first retransmission of the same SDUs. If the first retransmission is successful after a few HARQ retransmissions, the second retransmission is useless but wastes the transmission resource.

### Second Problem: Unnecessary Retransmission of Outdated or Acknowledged Packets

FIG. 5 depicts a problem of unnecessary retransmission. In an Automatic Repeat Request, RLC ARQ, procedure, when the transmitter receives a NACK, NACK_SN, the transmitter considers the negative acknowledged service data unit, SDU, for retransmission. The transmitter may consider retransmission multiple times, but actual retransmission is performed once when the UE receives an uplink shared channel, UL-SCH, resource in uplink. Even if an acknowledgement, ACK, or discard indication is received for the same SDU whose retransmission has been already considered, e.g., scheduled, the scheduled retransmission is not cancelled. This has a problem of unnecessary retransmission of an acknowledged SDU or an outdated SDU.

The example scenario of FIG. 5 assumes that the transmitter receives two status reports from the receivers. The first status report indicates ACK_SN=10 and NACK_SN=2, 3, 5, 7, 8. Upon receipt of the first status report the transmitter considers SDU2, SDU3, SDU5, SDU7 and SDU8 for retransmission. However, the example of FIG. 5 assumes that the transmitter does not receive a transmission resource until the reception of a second status report. FIG. 5 shows the transmitter receiving the second status report before receipt of the transmission resource which was provided for the retransmission intended in response to the first status report. This second status report indicates ACK_SN=10 and NACK_SN=8. Based on the second status report, the transmitter considers SDU8 for retransmission. FIG. 5 shows that the transmitter receives a transmission resource to retransmit SDU8 for retransmission. Since SDU2, SDU3, SDU5, SDU7 and SDU8 are considered for retransmission, the transmitter performs a retransmission for SDU2, SDU3, SDU5, SDU7 and SDU8. However, the second status report indicates that SDU2, SDU3, SDU5 and SDU7 are acknowledged, so those transmissions, although performed in the prior art, are unnecessary.

What is needed are methods, apparatus, and/or techniques to address one or more of the foregoing problems in wireless communications associated with retransmissions.

### SUMMARY

In the first of its example aspects the technology disclosed herein concerns a node of a wireless communications system. The node comprises at least one processor comprising processor circuitry and transmitter circuitry. The at least one processor is configured to start a timer t-RxDiscard upon a communication failure and, upon making a first determination of expiration of the timer t-RxDiscard, generate a t-RxDiscard failure status report configured to preclude triggering by another node of a retransmission in response to receipt by the another node of the t-RxDiscard failure status report. The transmitter circuitry is configured to transmit the t-RxDiscard failure status report over a radio interface to the another node. In one example embodiment and mode and example implementation, the at least one processor is further configured to generate the t-RxDiscard failure status report to include an acknowledged sequence number, ACK_SN, but not to include a negative acknowledged sequence number NACK_SN. In one example embodiment and mode and example implementation, the at least one processor is further configured to generate the t-RxDiscard failure status report to include a field which is configured to preclude the another node from triggering the retransmission in response to the receipt of the t-RxDiscard failure status report. Methods of operating such nodes are also provided.

In another of its example aspects the technology disclosed herein concerns a node of a wireless communications system. The node comprises at least one processor comprising processor circuitry and receiver circuitry. The receiver circuitry configured to receive a t-RxDiscard failure status report over a radio interface from another node. The at least one processor is configured to ascertain or determine that the t-RxDiscard failure status report is configured to preclude triggering by the node of a retransmission in response to receipt of the t-RxDiscard failure status report. In one example embodiment and mode and example implementation, the at least one processor is further configured to determine that the t-RxDiscard failure status report is configured to include an acknowledged sequence number, ACK_SN, but not a negative acknowledged sequence number NACK_SN. In another example embodiment and mode and example implementation, the at least one processor is further configured to determine that the t-RxDiscard failure status report is configured to include a field which precludes the node from triggering the retransmission in response to the receipt of the t-RxDiscard failure status report. Methods of operating such nodes are also provided.

In another of its example aspects the technology disclosed herein concerns a node of a telecommunications system. The node comprises at least one processor which is configured to obtain a predetermined indication for a packet or a packet portion which has previously been transmitted and to avoid retransmission of the packet or the packet portion for which the predetermined indication has been obtained. In one example implementation, the node further comprises interface circuitry configured to receive, over a radio interface from another node, a status report with the predetermined indication for the packet or the packet portion which has previously been transmitted, wherein the predetermined indication is a positive acknowledgement for the packet or the packet portion, and wherein the at least one processor avoids retransmission of the packet or the packet portion by canceling a pending retransmission of the packet or the packet portion. In another example implementation, the predetermined indication is a discard indication for the packet or the packet portion. The discard indication may be obtained after receipt of the status report with the negative acknowledgement, and wherein the at least one processor avoids retransmission of the packet or the packet portion by canceling a pending retransmission of the packet or the packet portion. Alternatively or additionally, the discard indication may be obtained prior to receipt of the status report with the negative acknowledgement. Methods of operating such nodes are also provided.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 is a diagrammatic view depicting prior art transmission and reception operations involving a t-RxDiscard timer.

FIG. 3 is a diagrammatic view depicting a duplicate retransmission problem in the prior art transmission and reception operations involving a t-RxDiscard timer.

FIG. 4 is a diagrammatic view of a table depicting reception status for the duplicate retransmission scenario of FIG. 3.

FIG. 5 is a diagrammatic view depicting a prior art problem of unnecessary retransmission.

FIG. 6 is a schematic view depicting a generic communications system and method wherein a receiver node, upon t-RxDiscard expiry, generates a status report that precludes a transmitter node from a retransmission based on the t-RxDiscard timer.

FIG. 7 is a diagrammatic view depicting example, basic, representative acts performed according to a first example embodiment and mode of the communications system of FIG. 6.

FIG. 8 is a diagrammatic view of a table depicting reception status for the first example embodiment and mode of the communications system of FIG. 7.

FIG. 9 is a diagrammatic view depicting example, basic, representative acts performed according to a second example embodiment and mode of the communications system of FIG. 6.

FIG. 10 is a diagrammatic view of a table depicting reception status for the second example embodiment and mode of the communications system of FIG. 9.

FIG. 11 is a schematic view of a generic communications system of FIG. 6 showing in more detail example functionalities of a transmitter node and a receiver node RxN.

FIG. 12 is a diagrammatic view depicting a generic communications system and method wherein unnecessary retransmission is avoided.

FIG. 13 is a diagrammatic view depicting a generic communications system and method wherein unnecessary retransmission is avoided by cancelling a pending retransmission.

FIG. 14 is a diagrammatic view depicting a generic communications system and method wherein unnecessary retransmission is avoided upon receipt of a discard indication after receipt of a status report with negative acknowledgement.

FIG. 15 is a diagrammatic view depicting a generic communications system and method wherein unnecessary retransmission is avoided upon receipt of a discard indication before receipt of a status report with negative acknowledgement.

FIG. 16 is a schematic view of a generic communications system of FIG. 12 showing in more detail example functionalities of a transmitter node and a receiver node RxN.

FIG. 17 is a diagrammatic view showing example elements comprising electronic machinery which may comprise a wireless terminal, a radio access node, and a core network node according to an example embodiment and mode.

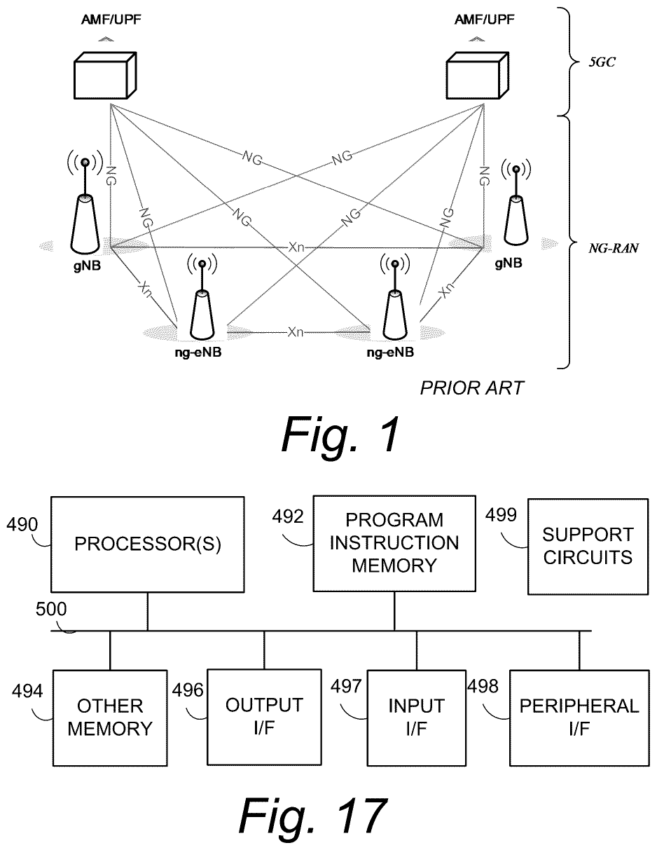

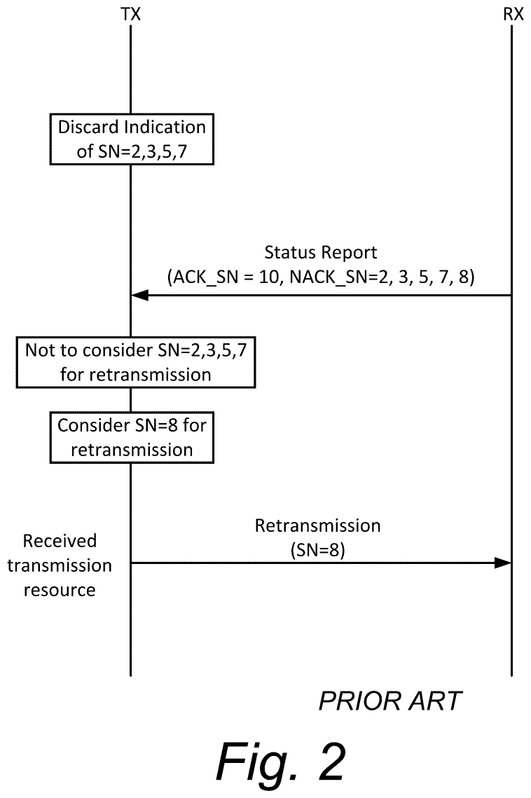

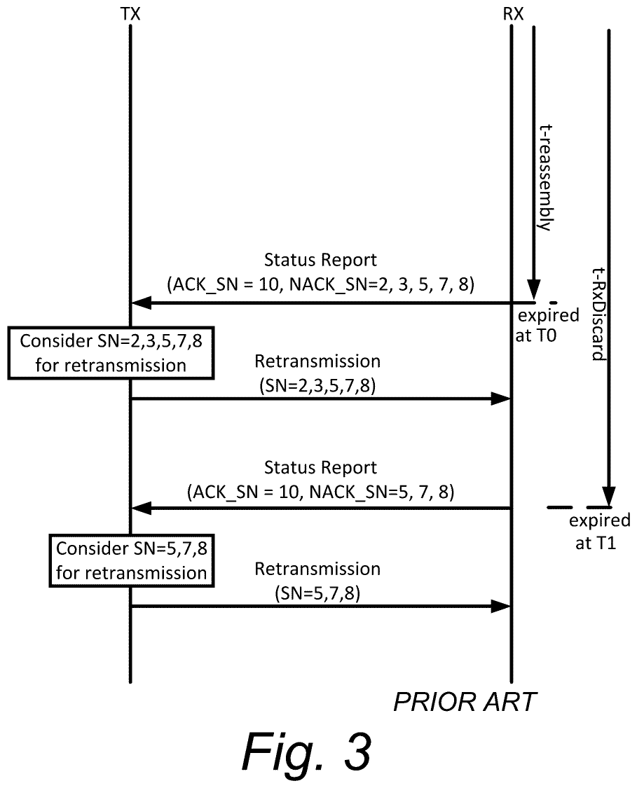

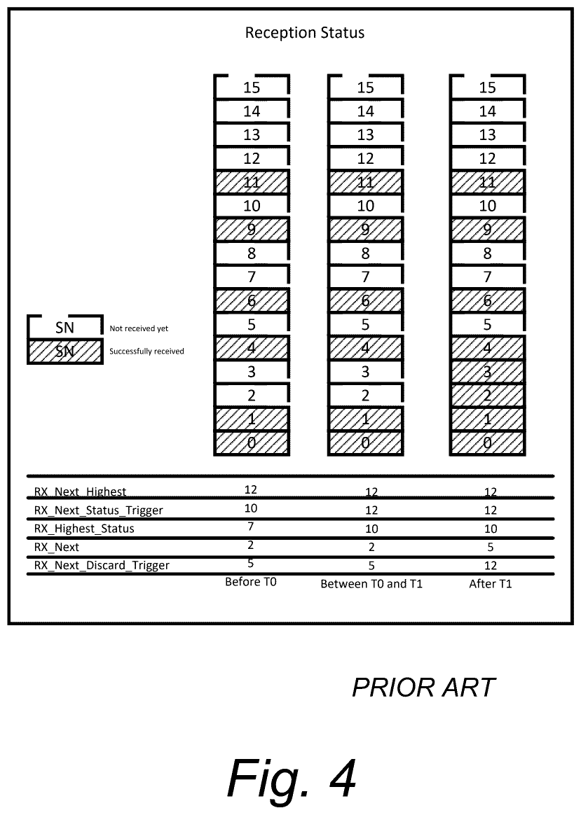

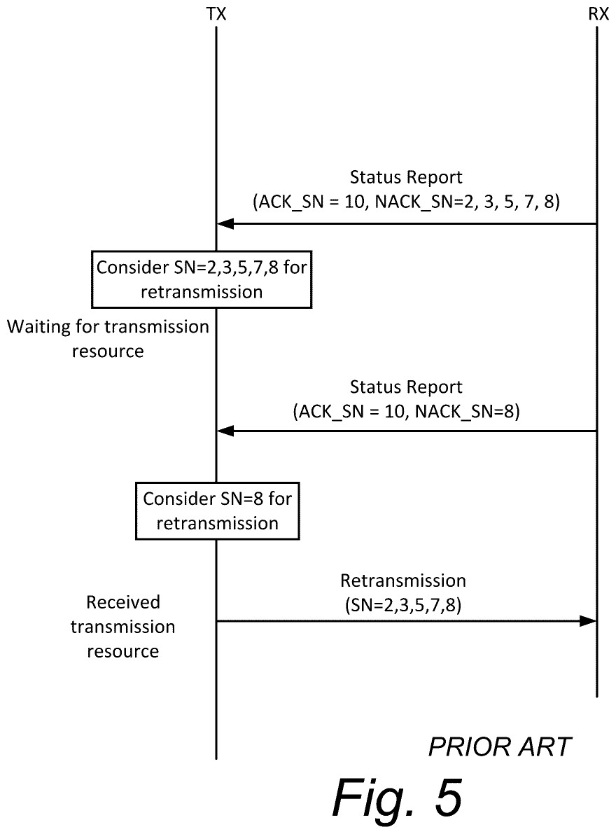

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “telecommunication system” or “communications system” can refer to any network of devices used to transmit information. A non-limiting example of a telecommunication system is a cellular network or other wireless communication system. As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”); IMT-2020, e.g., 5G; IMT-2030, e.g., 6G, etc. All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NG-RAN, 5G-RAN or 6G-RAN).

A core network (CN) may comprise numerous servers, routers, and other equipment. As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc. A core network may communicate over a RAN-CN interface (e.g., N2 interface) with one or more radio access networks (RAN).

A radio access network (RAN) may communicate with one or more core networks. A radio access network (RAN) typically comprises plural access nodes. As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology.

A radio access network (RAN) serves wireless terminals, which also form part of the radio access network (RAN). As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. In some non-limiting example embodiments and modes the wireless terminal node may operate in a half-duplex frequency-division duplexing mode.

A wireless terminal communicates with its serving radio access network (RAN) over a radio or air interface. Communication between radio access network (RAN) and wireless terminal over the radio interface occurs by utilization of “resources”. Any reference to a “resource” herein means “radio resource” unless otherwise clear from the context that another meaning is intended. In general, as used herein a radio resource (“resource”) is a time-frequency unit that can carry information across a radio interface, e.g., either signal information or data information.

Communication between radio access network (RAN) and wireless terminal over the radio interface may occur on various layers. Layer 1 includes radio layer 1 or the physical layer. Higher layers, e.g., layers higher than Layer 1 may include radio layer 2 and radio resource control layer 3. The layer 1 communication may occur by utilization of “resources”. Reference to a “resource” herein means “radio resource” unless otherwise clear from the context that another meaning is intended. In general, as used herein a radio resource (“resource”) is a time-frequency unit that can carry information across a radio interface, e.g., either signal information or data information.

An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two-dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element (RE) is the smallest time-frequency unit for downlink transmission in the subframe. That is, one symbol on one sub-carrier in the subframe comprises a resource element (RE) which is uniquely defined by an index pair (k, l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix

In 5G New Radio (“NR”), a frame consists of 10 ms duration. A frame consists of 10 subframes with each having 1 ms duration similar to LTE. Each subframe consists of 2^{μ} slots. Each slot can have either 14 (normal CP) or 12 (extended CP) OFDM symbols. A Slot is a typical unit for transmission used by scheduling mechanism. NR allows transmission to start at any OFDM symbol and to last only as many symbols as required for communication. This is known as “mini-slot” transmission. This facilitates very low latency for critical data communication as well as minimizes interference to other RF links. Mini-slots help to achieve lower latency in 5G NR architecture. Unlike slots, mini-slots are not tied to the frame structure. It helps in puncturing the existing frame without waiting to be scheduled. See, for example, https://www.rfwireless-world.com/5G/5G-NR-Mini-Slot. html, which is incorporated herein by reference.

In general, communication protocols between the wireless terminal and the telecommunication system may be categorized into Access Stratum (AS) and Non-Access Stratum (NAS). AS protocols, such as Radio Resource Control (RRC) and Medium Access Control (MAC), may be used for the wireless terminal to communicate with access nodes of a RAN, whereas NAS protocol(s), such as the NAS protocol specified in 3GPP TS 24.501, may be used for the wireless terminal to communicate with entities (e.g., AMF) of a CN(s), via access nodes of a RAN. Consequently, the wireless terminal may comprise a function to manage the AS protocols, and a separate function to manage the NAS protocol(s). Herein, terminology “NAS” may be used in some context to refer to the function built into the wireless terminal to manage the NAS protocol(s). Similarly, “RRC” may be used in some context to refer to the function built into the wireless terminal to manage the RRC protocol.

Logical channels reside between the RLC sublayer and the MAC sublayer which, as already mentioned, are layer 2 protocols in protocol stack. A Logical channel informs what kind of information is transferred. Logical channels can be broadly divided into two types: Control Channels (for the transfer of control plane information) and Traffic Channels (for the transfer of user plane information). A logical channel is eventually mapped to a physical channel.

The technology disclosed herein generally concerns and addresses one or more of the retransmission-related problems described above. For example, in various example embodiments and modes, the example embodiments and modes disclosed herein address, individually and/or collectively the problems of (1) duplicate retransmission(s), and (2) unnecessary retransmission(s). Section 1.0 hereof includes example embodiments and modes that address, e.g., the problem of duplicate retransmission(s). Section 2.0 hereof includes example embodiments and modes that address, e.g., the problem of unnecessary retransmission(s).

The descriptions of the example embodiments and modes of Section 1.0 and Section 2.0 hereof refer to a first node or transmitter node TxN and a second node or receiver node RxN. The transmitter node TxN and the receiver node RxN both engage in transmissions and receptions with one another over an air or radio interface. The term “transmitter” is applied to the transmitter node TxN in the sense that it is the node involved or potentially involved in a retransmission operation at a particular time. In a first example scenario of operation of the example embodiments and modes of each of Section 1.0 and Section 2.0, the first node or transmitter node TxN may be a wireless terminal, UE, and the second node or receiver node RxN may be a network node, such as a node of a radio access network, e.g., a base station node such as a gNB, for example. Alternatively, in another example scenario of operation of each of Section 1.0 and Section 2.0 hereof, the roles of the nodes may be reversed so that the first node or transmitter node TxN may be a network node and the second node or receiver node RxN may be a wireless terminal, UE. Although various figures and descriptions herein are described with reference to the first example scenario in which the first node or transmitter node TxN is a wireless terminal, UE, such examples are not limiting and accordingly the roles may be reversed in other example scenarios.

As used herein, “packet” may comprise at least one of a radio link control (RLC) service data unit (SDU) and a segment of an RLC SDU.

### 1.0: Status Report Signaling

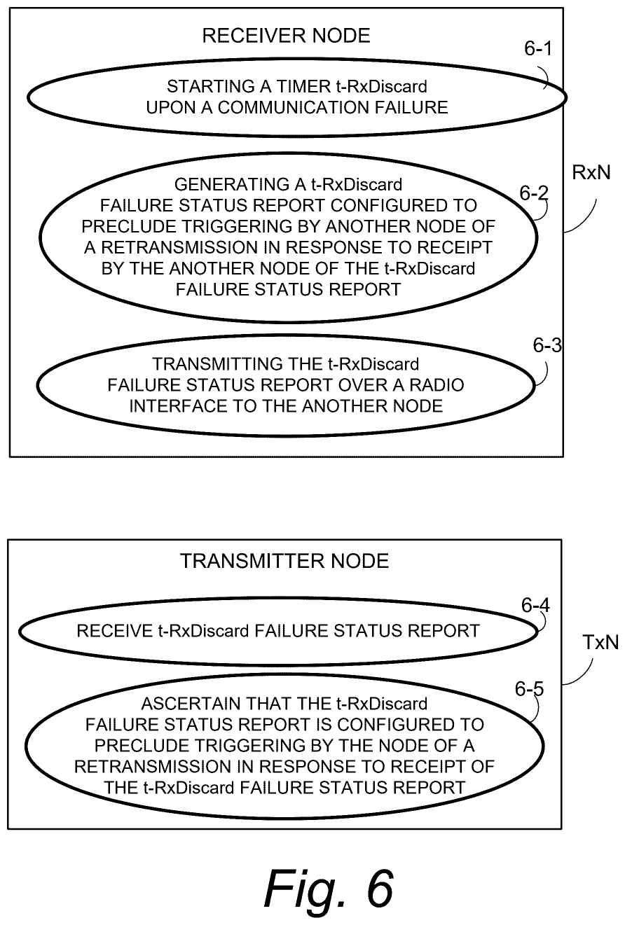

FIG. 6 illustrates an example generic communications system which addresses, e.g., the first problem described above, the problem of duplicate retransmission(s). For sake of simplicity, the generic communications system of FIG. 6 is shown as comprising a first node or transmitter node TxN and a second node or receiver node RxN. FIG. 6 particularly shows example generic acts that may be performed by the transmitter node TxN for addressing the problem of duplicate retransmission(s). As mentioned previously, as used herein, “packet” may comprise at least one of a radio link control (RLC) service data unit (SDU) and a segment of an RLC SDU.
Act 6-1 comprises receiver node RxN starting a timer t-RxDiscard upon [detection or notification of] a communication failure. As act 6-1, the timer t-RxDiscard may be started either upon detection by the receiver node RxN or notification to the receiver node RxN of the communication failure.
Act 6-2 comprises receiver node RxN, upon making a first determination of expiration of the timer t-RxDiscard, generating a t-RxDiscard failure status report configured to preclude triggering by another node of a retransmission in response to receipt by the transmitter node TxN of the t-RxDiscard failure status report.
Act 6-3 comprises receiver node RxN transmitting the t-RxDiscard failure status report over a radio interface to the transmitter node TxN.
Act 6-3 comprises transmitter node TxN receiving the t-RxDiscard failure status report over a radio interface from receiver node RxN.
Act 6-4 comprises receiver node RxN ascertaining or determining that the t-RxDiscard failure status report is configured to preclude triggering by the receiver node RxN of a retransmission in response to receipt of the t-RxDiscard failure status report.

As mentioned above, FIG. 6 shows a generic system and generic acts that may preclude triggering by the receiver node RxN of a retransmission in response to receipt of the t-RxDiscard failure status report. The generic system and method of FIG. 6 may be implemented in different embodiments, including the example embodiments and modes of section 1.1 and section 1.2 hereof.

### 1.1: Status Report Signaling With no NACK

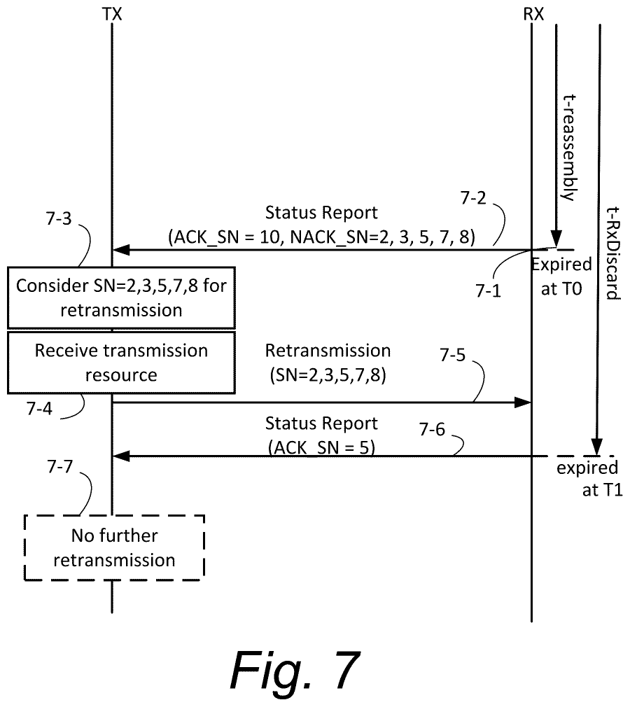

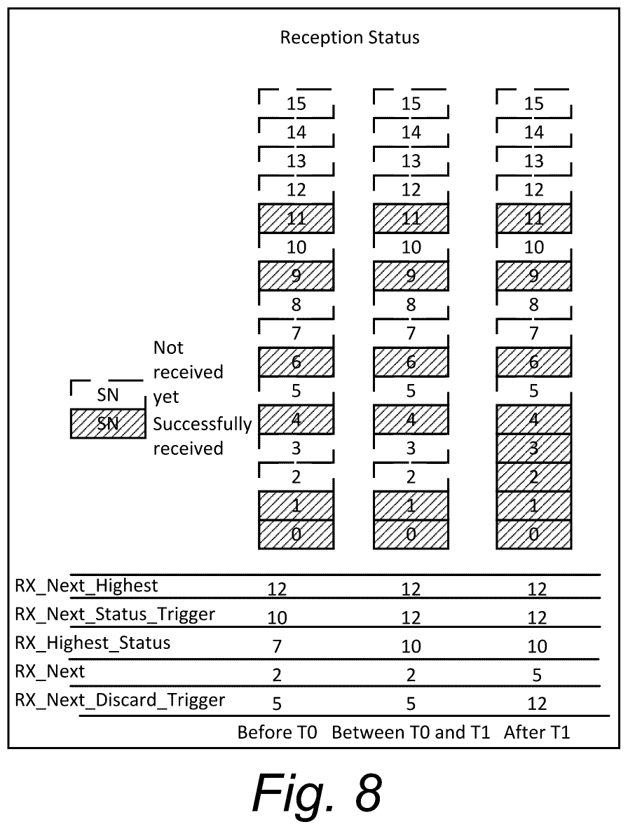

In a first example implementation example embodiment and mode of FIG. 6, the t-RxDiscard failure status report does not include a negative acknowledgement SDU, e.g., does not include a NACK. FIG. 7 depicts an example scenario of transmissions between a transmitter node TxN and a receiver node RxN in accordance with a first example implementation of the example embodiment and mode of FIG. 6. FIG. 8 depicts a reception status of packets according to an example scenario of FIG. 7. The FIG. 7 and FIG. 8 implementation avoids duplicate retransmission. As explained previously, a reason for the duplicate retransmission may be that t-RxDiscard timer expiry triggers a status report including NACK_SN which let the transmitter consider negative acknowledged SDUs for retransmission. The example implementation of FIG. 7 and FIG. 8 shows that a status report triggered by t-RxDiscard expiry does not include NACK_SN but includes only ACK_SN.

The example of FIG. 7 assumes and shows by act 7-1 that a timer, t-reassembly, expires at T0. As understood by the person skilled in the art, the timer t-reassembly runs at the receiving side of peer RLC entity; has a duration configured by RRC and which ranges from 0 ms to 200 ms; is configured for both UM & AM RLC mode of transmission; detects the loss of RLC PDUs; is started when a segment is received but more segments are pending for that SDU; and is stopped when SDU is completely received; and upon expiry, triggers a t-reassembly status reporting.

In the scenario of FIG. 7, the reception status immediately before T0 is that the receiver received SDU0, SDU1, SDU4, SDU6, SDU9 and SDU11 successfully, and all other SDUs are not received yet. The state variables RX_Next_Highest, RX_Next_Status_Trigger, RX_Highest_Status, RX_Next, and RX_Next_Discard_Trigger, which are maintained by the receiver node RxN and upon receipt by the receiver node RxN, are set to 12, 10, 7, 2, and 5, respectively. The definitions of those state variables are understood from 3GPP TS 38.322 V18.2.0 (2024-12), 3rd Generation Partnership Project; Technical Specification Group Radio Access Network; NR; Radio Link Control (RLC) protocol specification (Release 18), which is incorporated herein by reference. Simple definitions of these state variables are as follows:

RX_Next_Highest: This state variable holds the value of the SN following the SN of the RLC SDU with the highest SN among received RLC SDUs. It is initially set to 0.

RX_Next_Status_Trigger: This state variable holds the value of the SN following the SN of the RLC SDU which triggered t-Reassembly.
RX_Highest_Status: This state variable holds the highest possible value of the SN which can be indicated by “ACK_SN” when a STATUS PDU needs to be constructed. It is initially set to 0.
RX_Next: This state variable holds the value of the SN following the last in-sequence completely received RLC SDU, and it serves as the lower edge of the receiving window. It is initially set to 0 and is updated whenever the AM RLC entity receives an RLC SDU with SN=RX_Next.
RX_Next_Discard_Trigger: This state variable is used when the AM RLC entity is configured with t-RxDiscard. This state variable holds the value of the SN following the SN of the RLC SDU which triggered t-RxDiscard.

Upon t-reassembly expiry at T0, as act 7-2 a status report with ACK_SN=10 and NACK_SN=2, 3, 5, 7, 8 is triggered and sent to the transmitter, e.g., to transmitter node TxN. The receiver node RxN updates its state variables. In the particular example scenario of FIG. 7, the updated values of RX_Next_Highest, RX_Next_Status_Trigger, RX_Highest_Status, RX_Next, and RX_Next_Discard_Trigger are 12, 12, 10, 2, and 5, respectively.

As act 7-3, and based on the status report, the transmitter considers SDU2, SDU3, SDU5, SDU7, and SDU8 for retransmission. Thereafter, as shown by act 7-4, the transmitter receives a transmission resource. Upon receipt of a transmission resource, as act 7-5 the transmitter performs a retransmission for SDU2, SDU3, SDU5, SDU7, and SDU8. But the transmissions of act 7-5 may experience delay due to hybrid ARQ (HARQ) retransmissions. The example assumes that none of those SDUs are successfully transmitted to the receiver until t-RxDiscard expiry at T1.

Since, in the example scenario of FIG. 7, RX_Next_Discard_Trigger at the expiry of t-RxDiscard is 5, the receiver considers all unreceived SDUs whose SN is smaller than 5, i.e. SDU 2 and SDU 3, as outdated SDUs. The SDU 2 and SDU 3 are considered as received and RX_Next is updated to 5. Similar to t-reassembly expiry, as act 7-6 a t-RxDiscard status report is triggered and sent to the transmitter, e.g., to transmitter node TxN. However, the t-RxDiscard status report of act 7-6 does not include NACK_SN. To avoid giving a false impression that unreceived SDUs such as SDU5, SDU7, and SDU8 are interpreted as acknowledged SDU, the ACK_SN field of the t-RxDiscard status report should be set to a sequence number smaller than the sequence number, SN, of unreceived SDUs, e.g., set to the SN of the unreceived SDUs whose SN is greater than the ACK_SN, e.g., 5). In differing implementations, the ACK_SN field of the t-RxDiscard status report may be set according to different criteria or procedure. In the example of FIG. 7, ACK_SN is set to 5 which does not provide any information for SDUs whose SN is greater than or equal to 5. In an exemplary implementation, ACK_SN of the t-RxDiscard status report is set to the updated RX_NEXT. In another exemplary implementation, the ACK_SN of the t-RxDiscard status report is set to the SN of the first RLC SDU with SN greater than or equal to RX_Next_Discard_Trigger for which not all bytes have been received. Based on the t-RxDiscard status report, the receiver node RxN considers that all SDUs whose SN is smaller than 5 do not need to be retransmitted, and the transmitter node TxN updates its TX window accordingly. Also, the transmitter does not consider SDU5, SDU7, and SDU8 for retransmission. Act 7-7 of FIG. 7 reflects the fact that no retransmissions occur upon receipt of the t-RxDiscard status report. Hence, duplicate retransmission can be avoided.

Thus, in the example embodiment and mode and implementation of FIG. 7 and FIG. 8, a t-RxDiscard status report triggered by expiration of the t-RxDiscard times includes only ACK_SN information but does not include any NACK_SN. Moreover, in an example implementation, ACK_SN is set to (1) the updated RX_NEXT or (2) the SN of the first RLC SDU with SN greater than or equal to RX_Next_Discard_Trigger for which not all bytes have been received.

### 1.2: Status Report Signaling With Retranmission Preclusion field

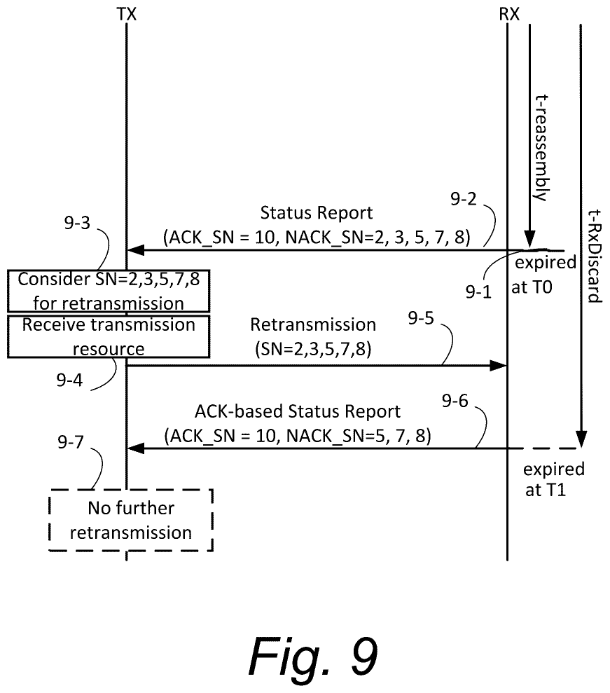

In a second example implementation example embodiment and mode of FIG. 6, the t-RxDiscard failure status report includes a field which is configured to preclude the receiver node RxN from triggering the retransmission in response to the receipt of the t-RxDiscard failure status report. FIG. 9 depicts an example scenario of transmissions between a transmitter node TxN and a receiver node RxN in accordance with a second example implementation of the example embodiment and mode of FIG. 6. FIG. 9 depicts a reception status of packets according to an example scenario of FIG. 8.

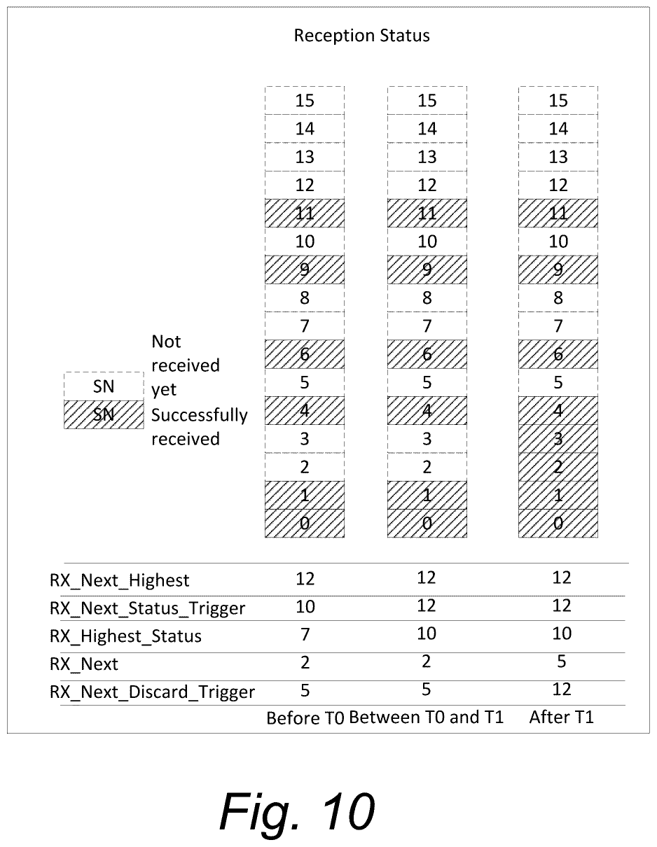

FIG. 9 and FIG. 10 depicts an example implementation to avoid duplicate retransmission. A reason for a duplicate retransmission may be that a t-RxDiscard timer expiry triggers a status report including NACK_SN which let the transmitter consider negative acknowledged SDUs for retransmission. The example of FIG. 9 and FIG. 10 shows that a status report triggered by t-RxDiscard expiry may include NACK_SN but NACK_SN and still does not trigger a retransmission. The status report triggered by t-RxDiscard expiry may be considered as a different type of RLC control PDU different from the status report triggered by t-reassembly expiry. The status report triggered by t-RxDiscard may use a different control PDU type field to identify it. In another implementation, the status report triggered by t-RxDiscard may be indicated by 1-bit indication in the status report. When the transmitter receives this status report triggered by t-RxDiscard, NACK_SN does not trigger any retransmission.

As shown by act 9-1, the example implementation of FIG. 9 assumes that t-reassembly expires at T0. The reception status immediately before T0 is that the receiver received SDU0, SDU1, SDU4, SDU6, SDU9 and SDU11 successfully, and all other SDUs are not received yet. In the example scenario of FIG. 9 the state variables RX_Next_Highest, RX_Next_Status_Trigger, RX_Highest_Status, RX_Next, and RX_Next_Disard_Trigger are set to 12, 10, 7, 2, and 5, respectively. The definition of those state variables have been previously provided. Upon t-reassembly expiry at T0, a as act 9-2 a t-reassembly expiration status report with ACK_SN=10 and NACK_SN=2, 3, 5, 7, 8 is triggered and sent to receiver node RxN. The receiver node RxN updates its state variables. In the particular scenario shown in FIG. 9, the updated values of RX_Next_Highest, RX_Next_Status_Trigger, RX_Highest_Status, RX_Next, and RX_Next_Disard_Trigger are 12, 12, 10, 2, and 5, respectively.

Based on the t-reassembly expiration status report, as act 9-3 the receiver node RxN considers SDU2, SDU3, SDU5, SDU7, and SDU8 for retransmission. When the transmitter receives a transmission resource, as depicted by act 9-4, as act 9-5 the transmitter performs a retransmission for SDU2, SDU3, SDU5, SDU7, and SDU8. But the transmissions of act 9-5 may experience delay due to hybrid ARQ (HARQ) retransmissions. The example of FIG. 9 and FIG. 10 assumes that none of those SDUs are successfully transmitted to the receiver until t-RxDiscard expiry at T1.

Since, in the example scenario of FIG. 9 and FIG. 10, RX_Next_Discard_Trigger at the expiry of t-RxDiscard is 5, the receiver node RxN considers all unreceived SDUs whose SN is smaller than 5, i.e. SDU 2 and SDU 3, as outdated SDUs. The SDU 2 and SDU 3 are considered as received and RX_Next is updated to 5. Similar to t-reassembly expiry, as act 9-6 a t-RxDiscard status report is triggered and sent to the transmitter node TxN. However, the t-RxDiscard status report of act 9-6 does not trigger a retransmission based on NACK_SN. To indicate that the t-RxDiscard status report of act 9-6 does not trigger a retransmission, the t-RxDiscard status report of act 9-6 can be identified as a new control PDU, or alternatively/additionally a one-bit indication may be used. In the example, ACK-based status report means a t-RxDiscard status report where NACK_SN does not trigger a retransmission. All other information in the t-RxDiscard status report may be the same as other status report triggered by t-reassembly expiry. In the example of FIG. 9, the t-RxDiscard status report with ACK_SN=10 and NACK_SN=5, 7, 8 is triggered and sent to transmitter node TxN. When the transmitter node TxN receives the t-RxDiscard status report of act 9-6 triggered by t-RxDiscard expiry, the transmitter node TxN does not consider any SDUs for retransmission, as reflected by act 9-7. Hence, duplicate retransmission can be avoided.

Thus, in the example embodiment and mode and example implementation of FIG. 9 and FIG. 10, a new status report, herein sometimes called “ACK-based status report” is introduced, and is used when t-RxDiscard expires. The ACK-based status report may include a new control PDU or 1-bit indication is used to identify the report. The ACK-based status report may include ACK_SN or NACK_SN but NACK_SN does not trigger any retransmission. In the example embodiment and mode of FIG. 9 and FIG. 10, ACK_SN is used to decide not to retransmit anymore.

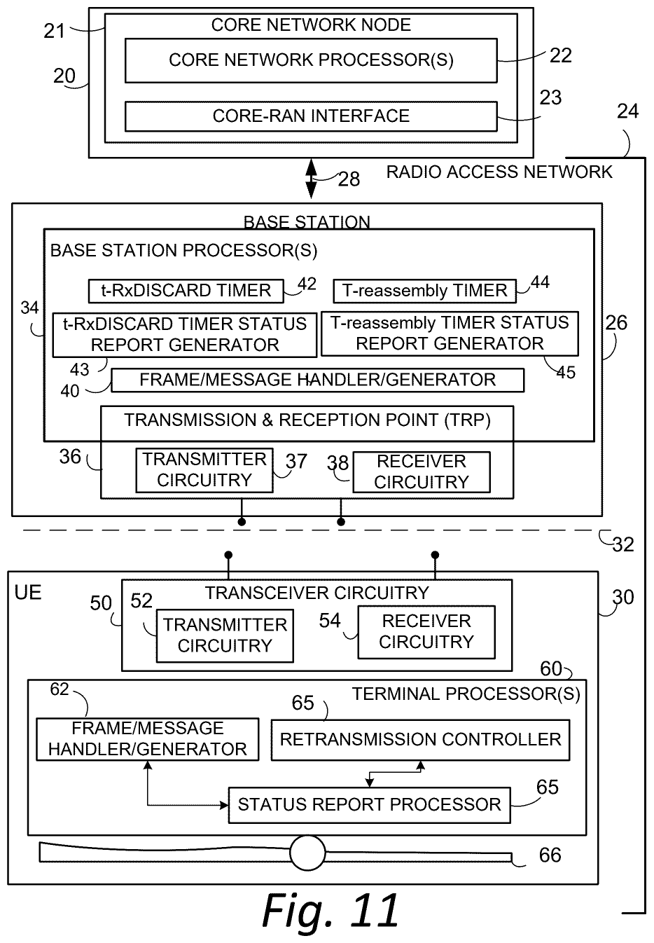

FIG. 11 shows in more detail an example implementation of a communications system which comprises a transmitter node TxN and a receiver node RxN and which may be utilized to implement the scenario and acts of FIG. 7 and/or the scenario and acts of FIG. 9. By way of non-limiting example, in the example implementation of FIG. 11 the receiver node RxN comprises a network node, e.g., network node 26, and the transmitter node TxN comprises a wireless terminal, UE, e.g., wireless terminal 30. Network node 26 and wireless terminal 30 communicate over a radio or air interface 32.

It should be understood that herein “network” may be used interchangeably with “network node”, except where otherwise clear from the context. Network node 28 may be either a core network node or a node of a radio access network, such as a RAN access node, e.g., a base station node, for example. In the example shown in FIG. 11, network node 26 comprises a radio access network. However, it should be understood that in other implementations and embodiments the network node may comprise a core network node. In example embodiments and modes in which the network node 26 is a core network node, it should be understood that the core network node communicates through a radio access node to other nodes, such as to the wireless terminal. Wireless terminal 30 may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. be any

FIG. 11 shows in example structures and functionalities that may comprise or be included in the communications network of FIG. 11. FIG. 11 shows that the example communications network, which may be 5G networks, for example, comprise core network 20. The core network 20 may comprise one or more core network nodes, such as core network node 21. The core network node 21 may comprise or be realized by any suitable type of core network node, such as a core network management entity, e.g., an Access and Mobility Management Function (AMF). One or more of the core network nodes 21 may comprise core node processor circuitry, such as core node processor(s) 22. The core network 20 and one or more of its constituent core network nodes 21 is connected to at least one radio access network 24 through a core-RAN interface circuit 23. The core-RAN interface circuit 23 may be connected to wireline(s) 28.

The radio access network 24 in turn comprises one or more radio access network (RAN) nodes, such as the example access node 26. The access node 26 serves at least one cell. The radio access network, RAN, 24 typically comprises plural access nodes, one example access node 26 being illustrated as a base station node in FIG. 11.

FIG. 11 shows the radio access network 24, and base station node 26 through its cell in particular communicating with wireless terminal 30 across a radio or air interface 32. The base station node 26 may, and usually does, communicate with plural wireless terminals across the air interface 32. Only one wireless terminal 30 is shown for sake of simplicity, it being understood that other wireless terminals may be provided and may operate in similar manner as the wireless terminal 30 herein illustrated.

In the example embodiment and mode shown in FIG. 11, the base station node 26 serves as the receiver node RxN and the wireless terminal 30 serves as the transmitter node TxN. It should be understood, however, such as communications in an opposite direction, that the roles may be reversed so that the base station node 26 serves as the transmitter node TxN and the wireless terminal 30 serves as the receiver node RxN.

FIG. 11 shows base station node 26 as comprising base station processor circuitry which may comprise one or more base station processors 34, as well as base station transceiver circuitry 36. As illustrated in FIG. 11, the base station transceiver circuitry 36 may be a transmission and reception point (TRP). The transmission and reception point (TRP) 36 may further comprise transmitter circuitry 36 and receiver circuitry 37. The base station processors 34 may comprise frame/message handler/generator 40 which prepares and generates information including user data and messages, e.g., signaling, for transmission over the radio interface 32, as which also processes information received over the radio interface 32. The base station processors 34 may also include t-RxDiscard timer 42, t-RxDiscard timer status report generator 43, t-reassembly timer 44, and t-reassembly timer status report generator 45.

Upon expiration of the t-reassembly timer 44, as depicted by act 7-1 for the example embodiment and mode of FIG. 7 or by act 9-1 of the example embodiment and mode of FIG. 9, the t-reassembly timer status report generator 45 may generate the t-reassembly timer status report of act 7-2 or the t-reassembly timer status report of act 9-2 of the respective example embodiments and modes of FIG. 7 and FIG. 9. Similarly, upon expiration of the t-RxDiscard timer 42, the t-RxDiscard timer status report generator 43 mat generate the t-RxDiscard timer status report of act 7-6 or the t-RxDiscard timer status report of act 9-6 for the of the respective example embodiments and modes of FIG. 7 and FIG. 9.

The base station node 26 may be structured essentially as shown in FIG. 11 or may be a node having architecture such as split architecture comprising a central unit and one or more distributed units that comprise mobile termination (MT). The base station processor(s) may include one or more TRPs.

FIG. 11 also shows various example constituent components and functionalities of wireless terminal 30. For example, FIG. 11 shows wireless terminal 30 as comprising terminal transceiver circuitry 50. The transceiver circuitry 50 in turn may comprise terminal transmitter circuitry 52 and terminal receiver circuitry 54. The terminal transceiver circuitry 50 may include antenna(e) for the wireless transmission. Terminal transmitter circuitry 52 may include, e.g., amplifier(s), modulation circuitry and other conventional transmission equipment. Terminal receiver circuitry 54 may comprise, e.g., amplifiers, demodulation circuitry, and other conventional receiver equipment.

FIG. 11 further shows wireless terminal 30 also comprising wireless terminal processor circuitry, e.g., one or more wireless terminal processor(s) 60. The wireless terminal 30, e.g., wireless terminal processor(s) 60, may comprise terminal frame or message handler/generator 62. The wireless terminal processor(s) 60 may also comprise status report processor 64 and retransmission controller 65. The status report processor 64 serves, e.g., to analyze the t-reassembly timer status report and t-RxDiscard timer status report of the respective example embodiments and modes of FIG. 7 and FIG. 9. The retransmission controller 65 serves, e.g., to generate the retransmissions of act 7-5 and act 9-5 of the respective example embodiments and modes of FIG. 7 and FIG. 9, and to refrain from any further retransmissions in the situations described herein as reflected by act 7-7 and act 7-9 of the respective example embodiments and modes of FIG. 7 and FIG. 9.

The wireless terminal 30 may also comprise terminal user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

### 2.0: Retransmission Avoidance

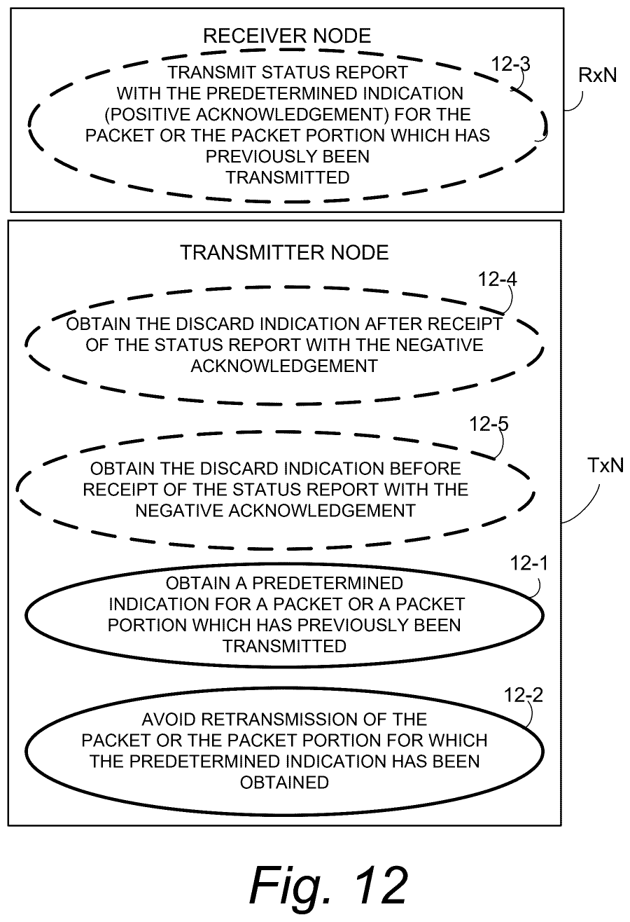

FIG. 12 illustrates an example generic communications system which addresses, e.g., the second problem described above, the problem of unnecessary retransmission(s). For sake of simplicity, the generic communications system of FIG. 12 is shown as comprising a first node or transmitter node TxN and a second node or receiver node RxN. FIG. 12 particularly shows example generic acts that may be performed by the transmitter node TxN for addressing the problem of unnecessary retransmission(s). As mentioned previously, as used herein, “packet” may comprise at least one of a radio link control (RLC) service data unit (SDU) and a segment of an RLC SDU.

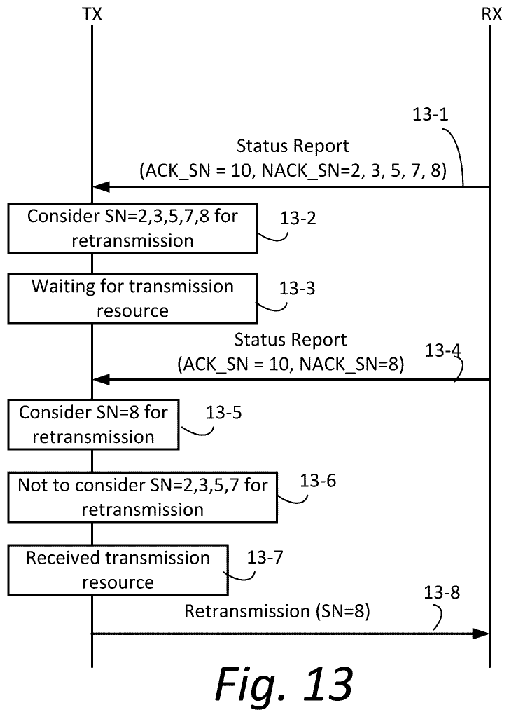

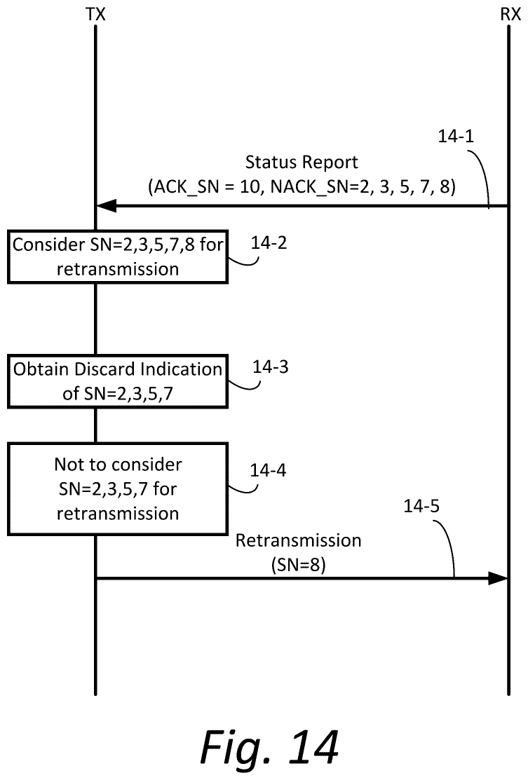

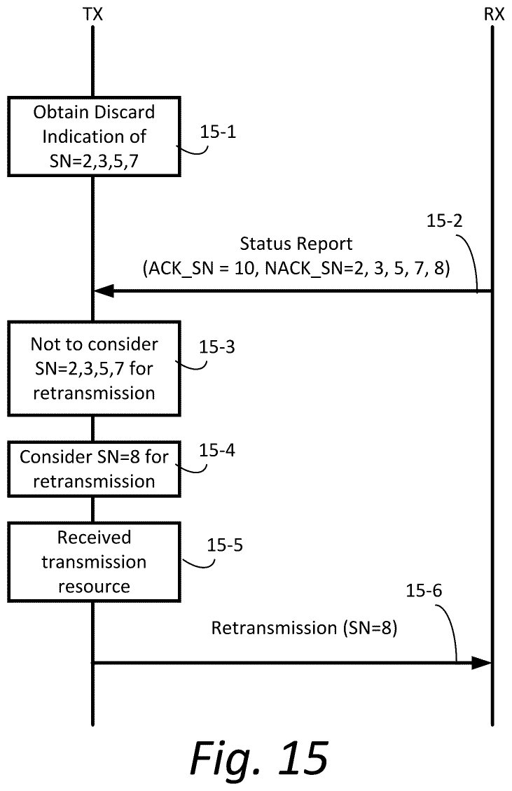

The technology disclosed herein encompasses several example embodiments and modes which avoid unnecessary retransmission, including the example embodiments and modes of FIG. 13, FIG. 14, and FIG. 15. FIG. 12 illustrates various acts which may be performed in conjunction with one or more of the example embodiments and modes of FIG. 13, FIG. 14, and FIG. 15. Act 12-1 and act 12-2 are illustrated in solid lines and thus may be common to all of the example embodiments and modes of FIG. 13, FIG. 14, and FIG. 15, other acts of FIG. 12 are illustrated in broken lines and thus may be specific to one or more but not necessarily all of the example embodiments and modes of FIG. 13, FIG. 14, and FIG. 15.
Act 12-1 comprises the transmitter node TxN obtaining a predetermined indication for a packet or a packet portion which has previously been transmitted.
Act 12-2 comprises the transmitter node TxN avoiding retransmission of the packet or the packet portion for which the predetermined indication has been obtained. The example embodiments and modes of FIG. 13, FIG. 14, and FIG. 15 may utilize different techniques for avoiding unnecessary retransmission, as described below.
Act 12-3 may be performed for the example embodiment and mode of FIG. 13, and comprises the receiver node RxN sending, and thus the transmitter node TxN receiving, over a radio interface, a status report. The status report comprises the predetermined indication for the packet or the packet portion which has previously been transmitted. The predetermined indication is a positive acknowledgement for the packet or the packet portion. In the example embodiment and mode of FIG. 13, the transmitter node TxN retransmission of the packet or the packet portion by canceling a pending retransmission of the packet or the packet portion
Act 12-4 may be performed for the example embodiment and mode of FIG. 14 and comprises the transmitter node TxN obtaining a discard indication after receipt of a status report with a negative acknowledgement. In the example embodiment and mode of FIG. 14, the transmitter node TxN avoids retransmission of the packet or the packet portion by canceling a pending retransmission of the packet or the packet portion.
Act 12-5 may be performed for the example embodiment and mode of FIG. 15 and comprises the transmitter node TxN obtaining a discard indication before receipt of a status report with a negative acknowledgement. In the example embodiment and mode of FIG. 15, the transmitter node TxN avoids retransmission of the packet or the packet portion by not retransmitting the packet or the packet portion.

### 2.1: Retransmission Avoidance: Cancelling NACKed Packet

FIG. 13 depicts an example embodiment and mode to avoid unnecessary retransmission. In an Automatic Repeat Request, RLC ARQ, procedure, when a transmitter receives a NACK, e.g., a NACK_SN, the transmitter considers the negative acknowledged SDU for retransmission. The transmitter may consider retransmission multiple times, but actual retransmission is performed once when the transmitter, e.g., UE, receives an uplink shared channel, UL-SCH, resource in uplink. However, in the example embodiment and mode of FIG. 13, if the transmitter receives an ACK for an SDU which has already been considered for retransmission, the updated ACK information needs to cancel the consideration of the retransmission. In other words, when the transmitter receives ACK for SDU pending for retransmission, the transmitter cancels the triggered or considered retransmission.

The example embodiment and mode of FIG. 13 assumes that the transmitter, e.g., transmitter node TxN, receives two status reports from the receiver, e.g., from the receiver node RxN. The first status report, reflected by act 13-1, indicates ACK_SN=10 and NACK_SN=2, 3, 5, 7, 8. As act 13-2 the transmitter node TxN considers SDU2, SDU3, SDU5, SDU7 and SDU8 for retransmission, e.g., as a first set of one or more data units of the packet for which reception is negatively acknowledged. In this regard, the transmitter node TxN makes a first determination from the first status report of a first set of one or more data units of the packet for which reception is negatively acknowledged. However, the example scenario of FIG. 13 assumes that the transmitter node TxN does not receive a transmission resource until the reception of the second status report. FIG. 13 shows, as act 13-3, the transmitter node TxN waiting for an uplink transmission resource. Meanwhile, e.g., while waiting for the uplink transmission resource, as act 13-4 the transmitter node TxN receives the second status report from the receiver node RxN receiver. This second status report of act 13-4 indicates ACK_SN=10 and NACK_SN=8. Upon receipt of the second status report of act 13-4, the transmitter node TxN considers SDU2, SDU3, SDU5 and SDU7 as a second set of more data units of the packet for which reception is positively acknowledged and considers SDU 8 as a third set of one or more data units of the packet, the third set being for one or more data units of the packet for which reception is negatively acknowledged. Thus, the transmitter node TxN makes a second determination from the second status report of a second set of one or more data units of the packet for which reception is positively acknowledged, e.g., the set of SDU2,SDU3, SDU5, and SDU7. Based on the status report of act 13-4, as act 13-5 the transmitter node TxN considers SDU8, the third set, for retransmission. The second status report of act 13-4 indicates that the receiver node RxN does not want to receive SDU2, SDU3, SDU5, and SDU7 anymore. In this case, and as reflected by act 13-6, the transmitter node TxN cancels the retransmission of SDU2, SDU3, SDU5 and SDU7, the second set of data units of the packet, by not considering SDU2, SDU3, SDU5 and SDU7 for retransmission anymore. When, as shown by act 13-7, the transmitter node TxN receives a transmission resource, only SDU8, the third set of one or more data units, is considered for retransmission. Act 13-8 comprises the transmitter node TxN performs a retransmission for SDU8. Hence, the example embodiment and mode of FIG. 13 shows that the prior art unnecessary retransmission problem can be avoided.

### 2.2: Retransmission Avoidance: Discard Indication After NACK

FIG. 14 depicts an example embodiment and mode which also avoids unnecessary retransmission. In an Automatic Repeat Request, RLC ARQ, procedure, when the transmitter node TxN receives a negative acknowledge, e.g., NACK, NACK_SN, the transmitter node TxN considers the negative acknowledged SDU for retransmission. The transmitter node TxN may consider retransmission multiple times, but actual retransmission is performed once when the transmitter node TxN, e.g., the UE, receives an uplink shared channel, UL-SCH, resource in uplink. However, if the transmitter node TxN receives a discard indication for an SDU which has already been considered for retransmission, the transmitter needs to cancel the consideration of the retransmission. The discard indication from the Packet Data Convergence Protocol, PDCP) layer implies that the corresponding SDU is already outdated. In other words, when the transmitter node TxN receives a discard indication for SDU pending for retransmission, the transmitter cancels the triggered or considered retransmission.

FIG. 14 shows as act 14-1 that the transmitter node TxN receives a status report from the receiver node RxN. The status report of act 14-1 indicates ACK_SN=10 and NACK_SN=2, 3, 5, 7, 8. As a result of receipt of the status report of act 14-1, as act 14-2 the transmitter node TxN considers SDU2, SDU3, SDU5, SDU7 and SDU8 for retransmission. However, the example scenario of FIG. 14 assumes that the transmitter node TxN does not receive a transmission resource until the reception of the discard indication for SDU2, SDU3, SDU5 and SDU7. Meanwhile, as shown by act 14-3, the transmitter node TxN receives a discard indication for SDU2, SDU3, SDU5 and SDU7 from the Packet Data Convergence Protocol, PDCP, layer of the transmitter node TxN. Thus, in the FIG. 14 scenario, the discard indication of act 14-3 is obtained after receipt of the status report with the negative acknowledgement, e.g., after receipt of the status report of act 14-1. The discard indication of act 14-3 requests the transmitter node TxN to discard the SDUs which have not been submitted to the lower layer. If the receiver node RxN receiver is configured with the timer t-RxDiscard, upon receipt of the discard indication of act 14-3 the transmitter node TxN can cancel the retransmission for SDU2, SDU3, SDU5 and SDU7. In this case, and as shown by act 14-4, the transmitter node TxN cancels the retransmission of SDU2, SDU3, SDU5 and SDU7 by not considering SDU2, SDU3, SDU5 and SDU7 for retransmission anymore. When the transmitter receives a transmission resource, only SDU8 is being considered for retransmission. Act 14-5 shows the transmitter node TxN performing a retransmission for SDU8. Hence, FIG. 14 shows another scenario in which the unnecessary retransmission problem can be avoided.

### 2.3: Retransmission Avoidance: Discard Indication Before NACK

FIG. 15 depicts another example embodiment and mode which, e.g., avoids unnecessary retransmission. In an Automatic Repeat Request, RLC ARQ, procedure, when the transmitter node TxN receives a negative acknowledgement, NACK, NACK_SN, the transmitter node TxN considers the negative acknowledged SDU for retransmission. The transmitter node TxN may consider retransmission multiple times, but actual retransmission is performed once when the transmitter node TxN, e.g., UE, receives a UL-SCH resource in uplink. However, for SDUs whose discard indication from the PDCP layer of the transmitter node TxN has been already received by the transmitter, the SDUs do not need be considered for retransmission. Thus, when the transmitter node TxN receives a NACK, the transmitter node TxN needs to check if a discard indication for the SDU from the PDCP layer of the transmitter node TxN has been received by the transmitter. If the transmitter node TxN already received a discard indication for an SDU, then NACK does not need to trigger a retransmission. If the transmitter node TxN has not received a discard indication for an SDU, then NACK can trigger a retransmission. When the transmitter node TxN receives a NACK for SDU whose discard indication from PDCP has been received, the transmitter node TxN does not consider the SDU for retransmission. When the transmitter node TxN receives a NACK for SDU whose discard indication from PDCP has not been received, the transmitter node TxN considers the SDU for retransmission.

FIG. 15 shows as act 15-1 that the transmitter node TxN receives a discard indication for SDU2, SDU3, SDU5 and SDU7. Later, as shown by act 15-2, the transmitter node TxN receives a status report from receiver node RxN. The status report of act 15-2 indicates ACK_SN=10 and NACK_SN=2, 3, 5, 7, 8. The transmitter node TxN then checks if a discard indication has been received for the SDUs which were negatively acknowledged in the status report of act 15-2. Since, at act 15-1, the transmitter node TxN received a discard indication for SDU2, SDU3, SDU5 and SDU7 prior to receipt of the status report of act 15-2, as act 15-3 the transmitter node TxN does not consider the SDUs which were negatively acknowledged for retransmission. Since the transmitter node TxN has not received a discard indication for SDU8, as act 15-4 the transmitter node TxN considers SDU8 for retransmission. When, as shown by act 15-5, the transmitter node TxN receives a transmission resource, only SDU8 is being considered for retransmission. Act 15-6 comprises the transmitter node TxN performing a retransmission for SDU8. Hence, FIG. 15 shows another example embodiment and mode in which unnecessary retransmission problem can be avoided.

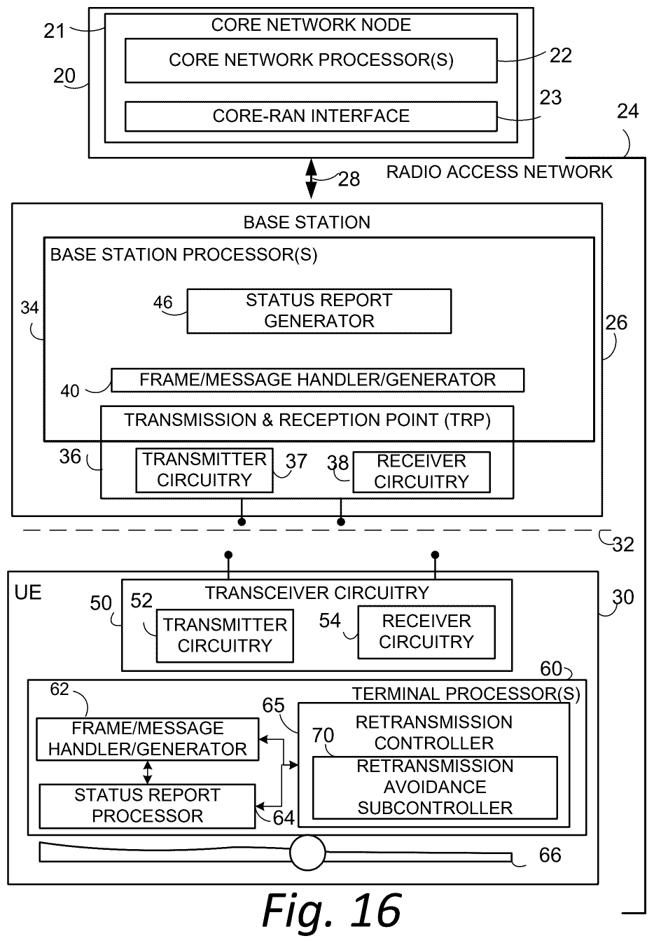

FIG. 16 shows in more detail an example implementation of a communications system which comprises a transmitter node TxN and a receiver node RxN and which may be utilized to implement the generic scenario and acts of FIG. 12, as well as the example embodiments and modes and acts of FIG. 13, FIG. 14, and FIG. 15. By way of non-limiting example, in the example implementation of FIG. 16 the receiver node RxN comprises a network node, e.g., network node 26, and the transmitter node TxN comprises a wireless terminal, UE, e.g., wireless terminal 30. Network node 26 and wireless terminal 30 communicate over a radio or air interface 32.

It should be understood that herein “network” may be used interchangeably with “network node”, except where otherwise clear from the context. Network node 28 may be either a core network node or a node of a radio access network, such as a RAN access node, e.g., a base station node, for example. In the example shown in FIG. 16, network node 26 comprises a radio access network. However, it should be understood that in other implementations and embodiments the network node may comprise a core network node. In example embodiments and modes in which the network node 26 is a core network node, it should be understood that the core network node communicates through a radio access node to other nodes, such as to the wireless terminal. Wireless terminal 30 may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. be any

FIG. 16 shows in example structures and functionalities that may comprise or be included in the communications network of FIG. 16. FIG. 16 shows that the example communications network, which may be 5G networks, for example, comprise core network 20. The core network 20 may comprise one or more core network nodes, such as core network node 21. The core network node 21 may comprise or be realized by any suitable type of core network node, such as a core network management entity, e.g., an Access and Mobility Management Function (AMF). One or more of the core network nodes 21 may comprise core node processor circuitry, such as core node processor(s) 22. The core network 20 and one or more of its constituent core network nodes 21 is connected to at least one radio access network 24 through a core-RAN interface circuit 23. The core-RAN interface circuit 23 may be connected to wireline(s) 28.

The radio access network 24 in turn comprises one or more radio access network (RAN) nodes, such as the example access node 26. The access node 26 serves at least one cell. The radio access network, RAN, 24 typically comprises plural access nodes, one example access node 26 being illustrated as a base station node in FIG. 16.

FIG. 16 shows the radio access network 24, and base station node 26 through its cell in particular communicating with wireless terminal 30 across a radio or air interface 32. The base station node 26 may, and usually does, communicate with plural wireless terminals across the air interface 32. Only one wireless terminal 30 is shown for sake of simplicity, it being understood that other wireless terminals may be provided and may operate in similar manner as the wireless terminal 30 herein illustrated.

In the example embodiment and mode shown in FIG. 16, the base station node 26 serves as the receiver node RxN and the wireless terminal 30 serves as the transmitter node TxN. It should be understood, however, such as communications in an opposite direction, that the roles may be reversed so that the base station node 26 serves as the transmitter node TxN and the wireless terminal 30 serves as the receiver node RxN.

FIG. 16 shows base station node 26 as comprising base station processor circuitry which may comprise one or more base station processors 34, as well as base station transceiver circuitry 36. As illustrated in FIG. 16, the base station transceiver circuitry 36 may be a transmission and reception point (TRP). The transmission and reception point (TRP) 36 may further comprise transmitter circuitry 36 and receiver circuitry 37. The base station processors 34 may comprise frame/message handler/generator 40 which prepares and generates information including user data and messages, e.g., signaling, for transmission over the radio interface 32, as which also processes information received over the radio interface 32. The base station processors 34 may also include status report generator 46, which may generate the status report of act 14-1, for example.

The base station node 26 may be structured essentially as shown in FIG. 16 or may be a node having architecture such as split architecture comprising a central unit and one or more distributed units that comprise mobile termination (MT). The base station processor(s) may include one or more TRPs.

FIG. 16 also shows various example constituent components and functionalities of wireless terminal 30. For example, FIG. 16 shows wireless terminal 30 as comprising terminal transceiver circuitry 50. The transceiver circuitry 50 in turn may comprise terminal transmitter circuitry 52 and terminal receiver circuitry 54. The terminal transceiver circuitry 50 may include antenna(e) for the wireless transmission. Terminal transmitter circuitry 52 may include, e.g., amplifier(s), modulation circuitry and other conventional transmission equipment. Terminal receiver circuitry 54 may comprise, e.g., amplifiers, demodulation circuitry, and other conventional receiver equipment.

FIG. 16 further shows wireless terminal 30 also comprising wireless terminal processor circuitry, e.g., one or more wireless terminal processor(s) 60. The wireless terminal 30, e.g., wireless terminal processor(s) 60, may comprise terminal frame or message handler/generator 62. The wireless terminal processor(s) 60 may also comprise status report processor 64 and retransmission controller 65. The status report processor 64 serves, e.g., to process the status report of the respective example embodiments and modes of FIG. 13 and FIG. 14. The retransmission controller 65 serves, e.g., to generate the retransmissions of act 13-8, act 14-5, and act 15-6 of the respective example embodiments and modes of FIG. 13, FIG. 14, and FIG. 15. Furthermore, the retransmission controller 65 may comprise retransmission avoidance subcontroller 70 which cancels or inhibits retransmission of any packet or packet portion for which the predetermined indication of act 12-1 and act 12-2 has been obtained. For example, the retransmission avoidance subcontroller 70 may avoid, suppress, or inhibit retransmission of packet(s) or packet portion(s) as indicated by act 13-6, act 14-4, and/or act 15-3 of the respective example embodiments and modes of FIG. 13, FIG. 14, and FIG. 15.

The wireless terminal 30 may also comprise terminal user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

It should be understood that the example embodiments and modes of FIG. 13, FIG. 14, and FIG. 15 may be employed collectively. That is, any one or more of the example embodiments and modes of FIG. 13, FIG. 14, and FIG. 15 may be used in conjunction with any other one or more of the example embodiments and modes of FIG. 13, FIG. 14, and FIG. 15, so that any collective example embodiment and mode may, at a same time or at differing times, utilize more than one of the techniques of the example embodiments and modes of FIG. 13, FIG. 14, and FIG. 15.

### 3.0 Further Considerations

The outlined captions hereof are not technically limiting but only for textual organizational.

For the foregoing example embodiments and modes, units and functionalities of any example embodiment and mode which have the same reference numbers of other example embodiments and modes should be understood to be the same as structure and operation even if not discussed in the context of the example embodiment and mode, unless otherwise clear from the context.

As mentioned above, aspects of one or more of the various example embodiments and modes may be used in combination with one or more example embodiments and modes. For example, one or more of the example embodiments and modes hereof may be used in combination with one or more of the example embodiments and modes. Moreover, while some of the illustrations for the various example embodiments and modes of are shown as including structures, features, or acts of other example embodiments and modes, it should be understood that in some cases not all such structures, features, or acts of preceding and/or other example embodiments and modes need necessarily be included in order to accomplish the objectives of the discussed example embodiment and mode.

Each of the example embodiments and modes discussed herein encompass a computer program product in which processor circuitry or the like, such as wireless terminal processor(s) 60 and network node processors 34, execute instructions stored on a non-transitory memory to perform acts such as those above described.

In terms of wireless communication, the wireless terminal 30 may be either a wireless terminal such as user equipment or mobile station, or a network node. Similarly and conversely, the network node 26 may be either a wireless terminal such as user equipment or mobile station, or a network node. It should be understood that herein “network” may be used interchangeably with “network node”. A network node may be either a core network node or a node of a radio access network, such as a RAN access node, e.g., a base station node, for example. The wireless terminal UE may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. be any

A core network may comprise one or more core network nodes. A core network node may comprise or be realized by any suitable type of core network node entities, such as a core network management entity, e.g., an Access and Mobility Management Function (AMF). A core network and one or more of its constituent core network nodes is connected to at least one radio access network through a core-RAN interface circuit.

A radio access network in turn comprises one or more radio access network (RAN) nodes, such as a base station node. The base station node serves at least one cell. The radio access network, RAN, typically comprises plural access nodes. A base station node may have architecture such as split architecture comprising a central unit and one or more distributed units that comprise mobile termination (MT).

It should be understood that the various foregoing example embodiments and modes may be utilized in conjunction with one or more example embodiments and modes described herein. For example, the example embodiments and modes of all aspects of the technology disclosed herein, may be utilized in combination with one or more other example embodiments and modes disclosed herein.

Certain units and functionalities of the communications systems may be implemented by electronic machinery. For example, electronic machinery may refer to the processor circuitry described herein, such as network node processors 34 and wireless terminal processor(s) 60. Moreover, the term “processor circuitry” is not limited to mean one processor, but may include plural processors, with the plural processors operating at one or more sites, and with the at least one processor, e.g., plural processors, operating independently and/or concurrently. Moreover, as used herein the term “server” is not confined to one server unit but may encompass plural servers and/or other electronic equipment and may be co-located at one site or distributed to different sites.

The foregoing are not exhaustive lists as other units and functionalities may also be implemented by processor circuitry.

With these understandings, FIG. 17 shows an example of electronic machinery, e.g., processor circuitry, as comprising one or more processors 490, program instruction memory 492; other memory 494 (e.g., RAM, cache, etc.); input/output interfaces 496 and 497, peripheral interfaces 498; support circuits 499; and busses 500 for communication between the aforementioned units. The processor(s) 490 may comprise the processor circuitries described herein, for example, network node processors 34 and wireless terminal processor(s) 60.

A memory or register described herein may be depicted by memory 494, or any computer-readable medium, may be one or more of readily available memory such as random-access memory (RAM), read only memory (ROM), floppy disk, hard disk, flash memory or any other form of digital storage, local or remote, and is preferably of non-volatile nature, as and such may comprise memory. The support circuits 499 are coupled to the processors 490 for supporting the processor in a conventional manner. These circuits include cache, power supplies, clock circuits, input/output circuitry and subsystems, and the like.

The processes and methods of the disclosed embodiments may be implemented as a software routine. Alternatively or additionally, some or all of method steps that are disclosed therein may be performed in hardware as well as by a processor running software. As such, the embodiments may be implemented in software, as executed upon a computer system, in hardware as an application specific integrated circuit or other type of hardware implementation, or a combination of software and hardware. The software routines of the disclosed embodiments are capable of being executed on any computer operating system and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus, machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

The acts described herein may be performed by a software program product stored tangibly on a non-transitory computer-readable medium which, when executed by one or more processors as herein mentioned, performs such acts either in whole or in part.

Moreover, each functional block or various features of the wireless terminal 30 and network node 26 employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves, e.g., control of retransmissions in a communications system.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

What is claimed is:

1. A node of a wireless communications system, the node comprising:
at least one processor, comprising processor circuitry, which is configured, individually and/or collectively, to:
obtain a predetermined indication for a packet or a packet portion which has previously been transmitted; and,
avoid retransmission of the packet or the packet portion for which the predetermined indication has been obtained.

2. The node of claim 1, further comprising interface circuitry configured to receive, over a radio interface from another node, a status report with the predetermined indication for the packet or the packet portion which has previously been transmitted, wherein the predetermined indication is a positive acknowledgement for the packet or the packet portion, and wherein the at least one processor avoids retransmission of the packet or the packet portion by canceling a pending retransmission of the packet or the packet portion.

3. The node of claim 2,
wherein the interface circuitry is configured to receive, over a radio interface from another node, a first status report and a second status report for the packet;
wherein the at least one processor is configured, individually and/or collectively, to:
make a first determination from the first status report of a first set of one or more data units of the packet for which reception is negatively acknowledged;
make a second determination from the second status report of a second set of one or more data units of the packet for which reception is positively acknowledged; and
cancel a pending retransmission of the one or more data units of the second set.

4. The node of claim 3, wherein
the at least one processor is further configured to generate a retransmission message which includes retransmission of only a third set of one or more data units of the packet for which reception was negatively acknowledged by the second status report; and
wherein the interface circuitry is further configured to transmit the retransmission message over the radio interface to the another node.

5. The node of claim 3, wherein the at least one processor is further configured to generate the retransmission message if the second status report is received while the node awaits an uplink resource for a retransmission of the first set of one or more data units.

6. The node of claim 3, wherein the second set is a subset of the first set.

7. The node of claim 1, wherein the predetermined indication is a discard indication for the packet or the packet portion.

8. The node of claim 7, wherein the discard indication is received from a Packet Data Convergence Protocol, PDCP, layer of the node.

9. The node of claim 7, further comprising interface circuitry configured to receive, over a radio interface from another node, a status report with a negative acknowledgement for the packet or the packet portion for which the discard indication is obtained.

10. The node of claim 9, wherein the discard indication is obtained after receipt of the status report with the negative acknowledgement, and wherein the at least one processor avoids retransmission of the packet or the packet portion by canceling a pending retransmission of the packet or the packet portion.

11. The node of claim 9, wherein the discard indication is obtained prior to receipt of the status report with the negative acknowledgement.

12. A method of operating a node of a wireless communications system, the method comprising:
obtaining a predetermined indication for a packet or a packet portion which has previously been transmitted; and,
cancelling a pending retransmission of the packet or the packet portion for which the predetermined indication has been obtained.
